(19) United States
(12) Patent Application Publication
(10) Pub. No.: US 2017/0318041 A1
(43) Pub. Date: Nov. 2, 2017

(54) METHOD AND SYSTEM FOR DETECTING MALICIOUS BEHAVIOR, APPARATUS AND COMPUTER STORAGE MEDIUM

(71) Applicant: BAIDU ONLINE NETWORK TECHNOLOGY (BEIJING) CO., LTD., Beijing (CN)

(72) Inventor: Rongxin ZOU, Beijing (CN)

(73) Assignee: BAIDU ONLINE NETWORK TECHNOLOGY (BEIJING) CO., LTD., Beijing (CN)

(21) Appl. No.: 15/528,291

(22) PCT Filed: Oct. 22, 2015
(86) PCT No.: PCT/CN2015/092567

§ 371 Date: May 19, 2017

(30) Foreign Application Priority Data
Jun. 30, 2015 (CN) 201510386083.7

(51) Int. Cl. H04L 29/06; H04L 29/08

(52) U.S. Cl. CPC H04L 63/1416; H04L 67/146

(57) ABSTRACT

The present disclosure provides a method and system for detecting a malicious behavior, an apparatus and a computer storage medium. In one aspect, in embodiments of the present disclosure, an internet protocol IP address corresponding to a Uniform Resource Locator URL accessed by a client is acquired as an IP address to be detected; therefore, malicious behavior detection is performed for the IP address to be detected, to obtain a detection result. Hence, technical solutions provided by embodiments of the present disclosure use the IP address to implement malicious behavior detection to solve the problem in the prior art that the attacker eludes the detection of the malicious behaviors by means of constantly changing a domain name or updating content of the malicious files, and can improve a successful detection rate of the malicious behavior.

The present disclosure claims priority to the Chinese patent application No. 201510386083.7 entitled “Method and System for Detecting Malicious Attack” filed on the filing date Jun. 30, 2015, the entire disclosure of which is hereby incorporated by reference in its entirety.

### FIELD OF THE DISCLOSURE

The present disclosure relates to the technical field of computers, and particularly to a method and system for detecting a malicious behavior, an apparatus and a computer storage medium.

### BACKGROUND OF THE DISCLOSURE

As the Internet technologies develop rapidly, a lot of malicious attack behaviors occur in the network. By using a physical device and using resources retrieved from the network, an attacker launches a malicious attack behavior on the network, for example, performs automatic update and download of a botnet, automatic update and download of a malicious code, phishing, using a network automation scanner or a spam for automatic sending, or the like.

In the prior art, a conventional detection software is used to detect the malicious behaviors, for example, an anti-virus collects a Uniform Resource Locator (URL) and malicious files used by the attacker, and then detects malicious behaviors for the URL and malicious files. However, the attacker eludes the detection of the anti-virus software and reduces a successful detection rate of malicious behaviors by means of for example constantly changing a domain name of the URL or updating content of the malicious files.

### SUMMARY OF THE DISCLOSURE

In view of the above, embodiments of the present disclosure provide a method and system for detecting a malicious behavior, an apparatus and a computer storage medium, which can solve the problem of constantly changing the domain name or updating content of the malicious file to elude detection of the malicious behavior in the prior art, and can improve the successful detection rate of the malicious behavior.

According to an aspect of the present disclosure, there is provided a method of detecting a malicious behavior, comprising:

acquiring an internet protocol IP address corresponding to a Uniform Resource Locator URL accessed by a client, as an IP address to be detected;

performing malicious behavior detection for the IP address to be detected, to obtain a detection result.

The above aspect and any possible implementation mode further provide an implementation mode: the performing malicious behavior detection for the IP address to be detected, to obtain a detection result comprises:

querying an IP address credit repository according to the IP address to be detected, to obtain a credit score of the IP address to be detected;

according to the credit score of the IP address to be detected, obtaining a detection result of the malicious behavior detection for the IP address to be detected.

The above aspect and any possible implementation mode further provide an implementation mode: before querying an IP address credit repository according to the IP address to be detected, to obtain a credit score of the IP address to be detected, the method further comprises:

collecting a malicious IP address;

obtaining the credit score of the malicious IP address according to at least one of a collection source of the malicious IP address and a data update frequency of the collection source;

correspondingly storing a normal IP address and a credit score of the normal IP address, the malicious IP address and a credit score of the malicious IP address, to generate the IP address credit repository.

The above aspect and any possible implementation mode further provide an implementation mode: the method further comprises:

according to a term of validity of the credit score, reducing the credit score of the malicious IP address after the term of validity, if the credit score of the malicious IP address in the IP address credit repository does not change within the term of validity.

The above aspect and any possible implementation mode further provide an implementation mode: the method further comprises:

if the detection result is that the IP address to be detected belongs to a malicious IP address, displaying a prompt information which is used to instruct the user to perform a corresponding operation, or,

if the detection result is that the IP address to be detected belongs to a normal IP address or unknown IP address, not display the prompt information.

According to another aspect of embodiments of the present disclosure, there is provided a system of detecting a malicious behavior, comprising:

an acquiring unit configured to acquire an internet protocol IP address corresponding to a Uniform Resource Locator URL accessed by a client, as an IP address to be detected.

a detecting unit configured to perform malicious behavior detection for the IP address to be detected, to obtain a detection result.

The above aspect and any possible implementation mode further provide an implementation mode: the detecting unit is specifically configured to:

query an IP address credit repository according to the IP address to be detected, to obtain a credit score of the IP address to be detected;

according to the credit score of the IP address to be detected, obtain a detection result of the malicious behavior detection for the IP address to be detected.

The above aspect and any possible implementation mode further provide an implementation mode: the system further comprises:

a collecting unit configured to collect a malicious IP address;

a calculating unit configured to obtain the credit score of the malicious IP address according to at least one of a collection source of the malicious IP address and a data update frequency of the collection source;

a storage unit configured to correspondingly store a normal IP address and a credit score of the normal IP address, the malicious IP address and a credit score of the malicious IP address, to generate the IP address credit repository.

The above aspect and any possible implementation mode further provide an implementation mode: the calculating unit is further configured to:

according to a term of validity of the credit score, reduce the credit score of the malicious IP address after the term of validity, if the credit score of the malicious IP address in the IP address credit repository does not change within the term of validity.

The above aspect and any possible implementation mode further provide an implementation mode: the system further comprises:

an output unit configured to, if the detection result is that the IP address to be detected belongs to a malicious IP address, display a prompt information which instructs the user to perform a corresponding operation, or, if the detection result is that the IP address to be detected belongs to a normal IP address or unknown IP address, not display the prompt information.

As can be seen from the above technical solutions, embodiments of the present disclosure have the following advantageous effects:

According to technical solutions provided by embodiments of the present disclosure, the IP address can be used to implement malicious behavior detection, and the malicious behavior detection is made with respect to the IP address. Hence, the technical solutions can solve the problem in the prior art that the attacker eludes the detection of the malicious behaviors by means of constantly changing a domain name or updating content of the malicious files. Hence, the technical solutions provided by embodiments of the present disclosure can improve a successful detection rate of malicious behaviors.

### BRIEF DESCRIPTION OF DRAWINGS

FIG. 1 is a flow chart of a method of detecting a malicious behavior according to an embodiment of the present disclosure;

FIG. 2 is a schematic diagram of a systematic architecture of a method of detecting a malicious behavior according to an embodiment of the present disclosure;

FIG. 3 is a block diagram of a system of detecting a malicious behavior according to an embodiment of the present disclosure.

### DETAILED DESCRIPTION OF PREFERRED EMBODIMENTS

The present disclosure will be described in detail in conjunction with figures and specific embodiments to make objectives, technical solutions and advantages of the present disclosure more apparent.

It should be appreciated that embodiments described here are only partial embodiments of the present disclosure, not all embodiments. Based on embodiments in the present disclosure, all other embodiments obtained by those having ordinary skill in the art without making inventive efforts all fall within the protection scope of the present disclosure.

Terms used in embodiments of the present disclosure are only intended to describe specific embodiments, not to limit the present disclosure. Singular forms “a”, “said” and “the” used in embodiments and claims of the present disclosure are also intended to include plural forms, unless other senses are clearly defined in the context.

It should be appreciated that the term “and/or” used in the text is only an association relationship depicting associated objects and represents that three relations might exist, for example, A and/or B may represents three cases, namely, A exists individually, both A and B coexist, and B exists individually. In addition, the symbol “/” in the text generally indicates associated objects before and after the symbol are in an “or” relationship. Depending on the context, the word “if” as used herein may be construed as “at the time when . . . ” or “when . . . ” or “responsive to determining” or “responsive to detecting”. Similarly, depending on the context, phrases “if . . . is determined” or “if . . . (stated condition or event) is detected” may be construed as “when . . . is determined” or “responsive to determining” or “when . . . (stated condition or event) is detected” or “responsive to detecting (stated condition or event)”.

### Embodiment 1

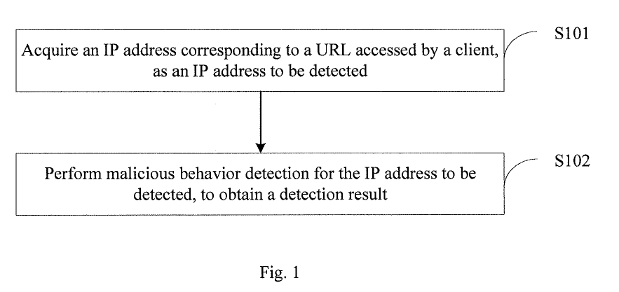

Embodiments of the present disclosure provide a method of detecting a malicious behavior. Referring to FIG. 1, FIG. 1 is a flow chart of a method of detecting a malicious behavior according to an embodiment of the present disclosure. As shown in FIG. 1, the method comprises the following steps:

S101: acquiring an IP address corresponding to URL accessed by a client, as an IP address to be detected.

S102: performing malicious behavior detection for the IP address to be detected, to obtain a detection result.

It needs to be appreciated that a subject for implementing S101-S102 may be a system for detecting a malicious behavior, and the system may be located in an application of a local terminal, or may further be a function unit such as a plug-in or Software Development Kit (SDK) located in the application of the local terminal, or may be located on a server side, or may be partially located at the local terminal and remaining portions are located on the server side. This is not particularly limited in the present embodiment.

It needs to be appreciated that the terminal involved in the embodiment of the present disclosure comprises but is not limited to a Personal Computer (PC), a Personal Digital Assistant (PDA), a wireless handheld device, a tablet computer, a mobile phone, an MP3 player, an MP4 player and the like.

It may be understood that the application may be a native application (nativeAPP) installed on the terminal, or a web application (webAPP) of a browser on the terminal. This is not specifically limited in the present embodiment.

### Embodiment 2

Based on the method for detecting the malicious behavior according to

Embodiment 1, Embodiment 2 of the present disclosure specifically describes the method in S101 of acquiring an IP address corresponding to a Uniform Resource Locator (URL) accessed by the client, as the method of detecting the IP address. The step may specifically comprise:

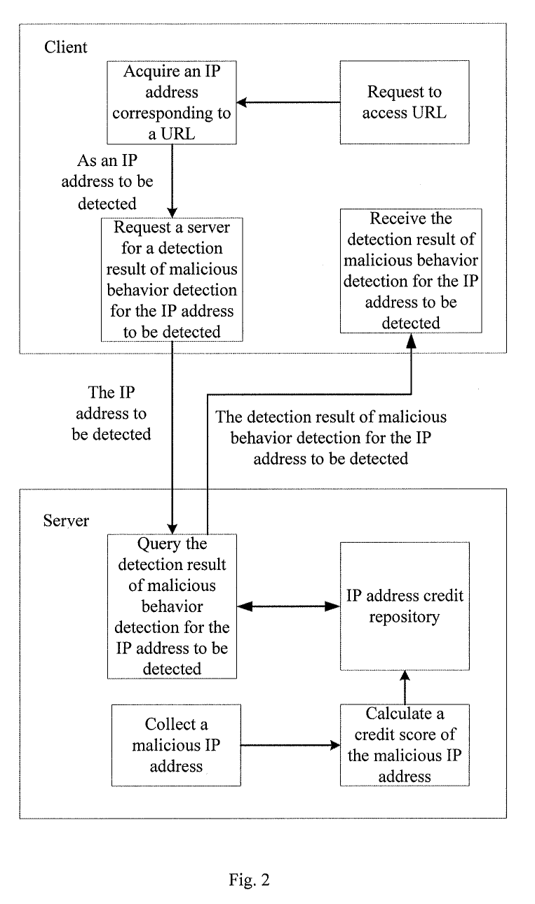

Referring to FIG. 2, FIG. 2 is a schematic diagram of a systematic architecture of a method of detecting a malicious behavior according to an embodiment of the present disclosure. It may be appreciated that as shown in FIG. 2, the subject for implementing S101 may be a client, or a server. If the subject implementing S101 is a client, the client may acquire an IP address corresponding to the URL accessed by the client, as the IP address to be detected. If the subject implementing S101 is a server, the client acquires an IP address corresponding to the URL accessed by the client, as the IP address to be detected, and then the client sends the acquired IP address to be detected to the server so that the server may receive the IP address to be detected sent by the client.

Exemplarily, in the embodiment of the present disclosure, the method of the client acquiring an IP address corresponding to the URL accessed by the client may comprise but is not limited to the following two types:

Type 1: the client sends a query request to a Domain Name System (DNS) according to the URL that the user requests to access. After receiving the query request, the domain name system acquires the domain name from the URL, and thereby queries in a mapping relationship of domain names stored in itself and the IP address, to obtain the IP address corresponding to the domain name included in the URL. The domain name system returns the IP address obtained from the query to the client, and the IP address may serve as the IP address corresponding to the URL accessed by the client.

Type 2: the client may, according to the URL that the user requests to access, initiate a Hyper Text Transfer Protocol (HTTP) for the URL. A server providing a page resource indicated by the URL, upon receipt of the HTTP request, obtains the page resource and IP address according to the URL that the user requests to access, and then packs the page resource and IP address and then sends it to the client. As such, the client may obtain, from the received data packet, the IP address corresponding to the accessed URL.

### Embodiment 3

Based on the method for detecting the malicious behavior according to Embodiment 1 and Embodiment 2, Embodiment 3 of the present disclosure specifically describes the method in S102 of performing malicious behavior detection for the IP address to be detected to obtain a detection result. The step may specifically comprise:

It needs to be appreciated that if the subject for implementing S101 is a client, the subject for implementing S102 may be a client or a server; if the subject for implementing S101 is a server, the subject for implementing S102 may be a server.

Exemplarily, the method of performing malicious behavior detection for the IP to be detected to obtain a detection result may comprise but is not limited to the following:

First, according to the IP address to be detected, querying an IP address credit repository to obtain a credit score of the IP address to be detected, and then according to the credit score of the IP address to be detected, obtaining a detection result of the malicious behavior detection for the IP address to be detected.

In a specific implementation procedure, before the step of, according to the IP address to be detected, querying an IP address credit repository to obtain a credit score of the IP address to be detected, it is necessary to pre-generate the IP address credit repository.

It needs to be appreciated that in the embodiment of the present disclosure, a server generates the IP address credit repository.

In a specific implementation procedure, if the subject for implementing S102 is a client, after the server generates the IP address credit repository, it is necessary to send the IP address credit repository to the client so that the client may, after obtaining the IP address to be detected, query the IP address credit repository to obtain a credit score of the IP address to be detected. Alternatively, as shown in FIG. 2, if the subject for implementing S102 is a server, if the server, after generating the IP address credit repository, receives the IP address to be detected sent from the client, it may directly query the IP address credit repository to obtain the credit score of the IP address to be detected.

Exemplarily, in the embodiment of the present disclosure, the method of the server generating the IP address credit repository may comprise but is not limited to:

As shown in FIG. 2, first, the server collects a malicious IP address. Then, the server obtains the credit score of the malicious IP address according to at least one of a collection source of the malicious IP address and a data update frequency of the collection source. Finally, the server correspondingly stores a normal IP address and a credit score of the normal IP address, the malicious IP address and a credit score of the malicious IP address, to generate the IP address credit repository.

It may be appreciated that the malicious IP address may comprise but is not limited to the following types of IP addresses: an IP address of botnet C&C, an IP address of a download source of a malicious code, an IP address corresponding to a phishing website, an IP address of a malicious scanning source, and an IP address of a spam sender.

In a specific implementation mode, the server may consider a data platform related to itself and a third-party data platform as a collection source of a malicious IP address, and thereby collects the malicious IP address from the data platform related to itself and the third-party data platform.

For example, the third-party data platform may comprise but is not limited to: common data platform such as Virustotal, Clean MX, MalcOde, Malware Domain List, OpenBL, Phishtank, Spy Eye Tracker, The Spamhaus Project, Zeus Tracker, Brute Force Blocker, and Chaos Reigns.

In a specific implementation mode, the server may collect the malicious IP address from the collection source according to a preset data update frequency, to implement update of the malicious IP address in the IP address credit repository. However, the data update frequencies of different collection sources may be the same or different. For example, some collection sources may be updated as per hour, some collection sources may be updated daily, and some collection sources may be updated weekly.

Exemplarily, the method of the server obtaining the credit score of the malicious IP address according to at least one of a collection source of the malicious IP address and a data update frequency of the collection source may comprise but is not limited to:

An initial score of each collected malicious IP address is 50 points. It is feasible to add a score on the basis of the initial score of the malicious IP address according to the collection source of the malicious IP data.

For example, if a certain malicious IP address is a malicious IP address collected from the data platform related to the server, the credit score of the malicious IP address is the initial score plus 15 points; if the collection source of a certain malicious IP address is one of the third-party data platforms, the credit score of the malicious IP address is the initial score plus 10 points; if the collection source of a certain IP address is at least two of the third-party data platforms, this means that the malicious IP address is confirmed as a malicious IP address in at least two data platforms, and the credit score of the malicious IP address is the initial score plus 30 points.

Furthermore, it is further feasible to increase the credit score of the malicious IP address according to the data update frequency of the collection source.

For example, if the data update frequency of the collection source of the malicious IP address is updated as per hour, the credit score of the malicious IP address may further increase by 10 points. If the data update frequency of the collection source of the malicious IP address is updated daily, the credit score of the malicious IP address may further increase by 5 points. If the data update frequency of the collection source of the malicious IP address is updated as per week or a longer time period, the credit score of the malicious IP address may not increase. If the malicious IP address is collected as a malicious IP address in consecutive 30 days upon updating, the credit score of the malicious IP address may further increase by 15 points. As such, it is feasible to obtain the credit score of the malicious IP address using any one of the above two methods of increasing scores, or use the above two methods of increasing scores together to obtain the credit score of the malicious IP address.

In a specific implementation procedure, it is further feasible to, according to a term of validity of the credit score, reduce the credit score of the malicious IP address after the term of validity, if the credit score of the malicious IP address in the IP address credit repository does not change within the term of validity.

For example, if the term of validity of the credit score is 30 days, and if the credit score of the malicious IP address in the IP address credit repository does not change within 30 days, it is feasible to, after 30 days, progressively reduce the credit score of the malicious IP address according to the previously-increased scores.

It needs to be appreciated that a minimum of the credit score of the malicious IP address is 1, and may not be progressively reduced to 0. In the embodiment of the present disclosure, the credit score of a normal IP address may be set as 0. The malicious IP address that occurred ever cannot be considered as the normal IP address even though its credit score is already reduced, so its credit score cannot be reduced to 0.

In a specific implementation procedure, it is feasible to correspondingly store the malicious IP address and the obtained credit score of the malicious IP address to generate the IP address credit repository. In addition, the generated IP address credit repository further needs to include a correspondence relationship between a normal IP address and a credit score of the normal IP address.

Preferably, the normal IP address may be manually collected, and a credit score may be configured for the normal IP address, for example, the credit score of the normal IP address may be configured as 0. As such, the IP address credit repository may correspondingly store the normal IP address and the credit score of the normal IP address.

Exemplarily, in the embodiment of the present disclosure, the method of obtaining a detection result of the malicious behavior detection for the IP address to be detected, according to the credit score of the IP address to be detected, may comprise but is not limited to:

For example, the credit score of the IP address to be detected is in a range of 0-100. If the credit score of the IP address to be detected is equal to 0, this indicates that the IP address to be detected belongs to a white list, and it is determined that the detection result of the malicious behavior detection for the IP address to be detected is that the IP address to be detected is a normal IP address. If the credit score of the IP address to be detected is larger than 0 and smaller than or equal to 50 points, the detection result of the malicious behavior detection for the IP address to be detected is that the IP address to be detected is an unknown IP address. If the credit score of the IP address to be detected is larger than 50 points and less than 75 points, the detection result of the malicious behavior detection for the IP address to be detected is that the

IP address to be detected is a suspicious malicious IP address. If the credit score of the IP address to be detected is larger than or equal to 75 points and less than or equal to 100 points, this indicates that the IP address to be detected belongs to a black list, and it is determined that the detection result of the malicious behavior detection for the IP address to be detected is that the IP address to be detected is a malicious IP address.

### Embodiment 4

Based on the method for detecting the malicious behavior according to Embodiment 1, Embodiment 2 and Embodiment 3, Embodiment 4 specifically describes optional steps of the method of detecting the malicious behavior. The step may specifically comprise:

As shown in FIG. 2, in a specific implementation procedure, if the subject for implementing S102 is a server, in this step the server outputs to the client the detection result of the malicious behavior detection for the IP address to be detected. If the detection result is that the IP address to be detected belongs to a malicious IP address, the client may display a prompt information to the user. The prompt information is used to instruct the user to perform a corresponding operation, for example, stop accessing the URL corresponding to the malicious IP address. Alternatively, if the detection result is that the IP address to be detected belongs to a normal IP address or unknown IP address, the client may not display a prompt information to the user, and he may continue to access the URL corresponding to the IP address to be detected.

It needs to be appreciated that if the server obtains the detection result of the malicious behavior detection for the IP address to be detected, and when the detection result is a malicious IP address, an unknown IP address or a normal IP address, the server may output the detection result to the client. When the detection result is an unknown IP address, the server may not output the detection result.

In a specific implementation procedure, if the subject for implementing S102 is a client, in this step, if the detection result is that the IP address to be detected belongs to a malicious IP address, the client may display a prompt information to the user. The prompt information is used to instruct the user to perform a corresponding operation, for example, stop accessing the URL corresponding to the malicious IP address. Alternatively, if the detection result is that the IP address to be detected belongs to a normal IP address or unknown IP address, the client may not display a prompt information to the user, and he may continue to access the URL corresponding to the IP address to be detected.

For example, the client may display the prompt information to the user in a window pop-up prompting manner.

Embodiments of the present disclosure further provide an apparatus embodiment for implementing steps in the above method embodiments and the method.

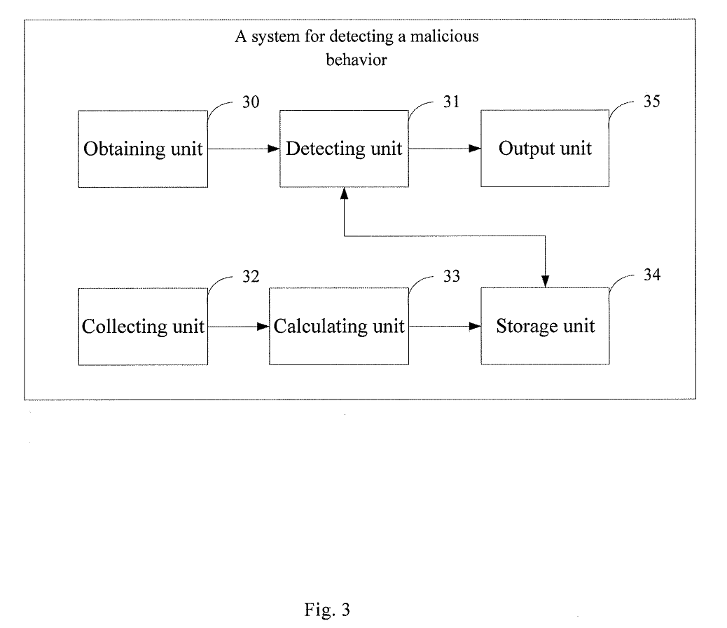

Referring to FIG. 3, FIG. 3 is a block diagram of a system of detecting a malicious behavior according to an embodiment of the present disclosure. As shown in FIG. 3, the system comprises:

an acquiring unit 30 configured to acquire an internet protocol IP address corresponding to a Uniform Resource Locator URL accessed by a client, as an IP address to be detected.

a detecting unit 31 configured to perform malicious behavior detection for the IP address to be detected, to obtain a detection result.

Preferably, the detecting unit 31 is specifically configured to:

query an IP address credit repository according to the IP address to be detected, to obtain a credit score of the IP address to be detected;

according to the credit score of the IP address to be detected, obtain a detection result of the malicious behavior detection for the IP address to be detected.

Optionally, the system further comprises:

a collecting unit 32 configured to collect a malicious IP address;

a calculating unit 33 configured to obtain the credit score of the malicious IP address according to at least one of a collection source of the malicious IP address and a data update frequency of the collection source;

a storage unit 34 configured to correspondingly store a normal IP address and a credit score of the normal IP address, the malicious IP address and a credit score of the malicious IP address, to generate the IP address credit repository.

Optionally, the calculating unit 33 is further configured to:

according to a term of validity of the credit score, reduce the credit score of the malicious IP address after the term of validity, if the credit score of the malicious IP address in the IP address credit repository does not change within the term of validity.

Optionally, the system further comprises:

an output unit 35 configured to, if the detection result is that the IP address to be detected belongs to a malicious IP address, display a prompt information which instructs the user to perform a corresponding operation, or, if the detection result is that the IP address to be detected belongs to a normal IP address or unknown IP address, not display the prompt information.

Since units in the present embodiment can execute the method shown in FIG. 1, reference may be made to related depictions of FIG. 1 for portions not described in detail in the present embodiment.

The technical solutions of embodiments of the present disclosure have the following advantageous effects:

In the embodiments of the present disclosure, an internet protocol IP address corresponding to a Uniform Resource Locator URL accessed by a client is acquired as an IP address to be detected; therefore, malicious behavior detection is performed for the IP address to be detected, to obtain a detection result.

According to technical solutions provided by embodiments of the present disclosure, the IP address can be used to implement malicious behavior detection, and the malicious behavior detection is made with respect to the IP address. Hence, the technical solutions can solve the problem in the prior art that the attacker eludes the detection of the malicious behaviors by means of constantly changing a domain name or updating content of the malicious files. Hence, the technical solutions provided by embodiments of the present disclosure can improve a successful detection rate of malicious behaviors.

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed system, apparatus and method can be implemented through other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

What are stated above are only preferred embodiments of the present disclosure, not intended to limit the disclosure. Any modifications, equivalent replacements, improvements and the like made within the spirit and principles of the present disclosure, should all be included in the present disclosure within the scope of protection.

What is claimed is:

1. A method of detecting a malicious behavior, wherein the method comprises:
acquiring an internet protocol IP address corresponding to a Uniform Resource Locator URL accessed by a client, as an IP address to be detected;
performing malicious behavior detection for the IP address to be detected, to obtain a detection result.

2. The method according to claim 1, wherein the performing malicious behavior detection for the IP address to be detected, to obtain a detection result comprises:
querying an IP address credit repository according to the IP address to be detected, to obtain a credit score of the IP address to be detected;
according to the credit score of the IP address to be detected, obtaining a detection result of the malicious behavior detection for the IP address to be detected.

3. The method according to claim 2, wherein the method further comprises:
collecting a malicious IP address;
obtaining the credit score of the malicious IP address according to at least one of a collection source of the malicious IP address and a data update frequency of the collection source;
correspondingly storing a normal IP address and a credit score of the normal IP address, the malicious IP address and a credit score of the malicious IP address, to generate the IP address credit repository.

4. The method according to claim 3, wherein the method further comprises:
according to a term of validity of the credit score, reducing the credit score of the malicious IP address after the term of validity, if the credit score of the malicious IP address in the IP address credit repository does not change within the term of validity.

5. The method according to claim 1, wherein the method further comprises:
if the detection result is that the IP address to be detected belongs to a malicious IP address, displaying a prompt information which is used to instruct the user to perform a corresponding operation; or,
if the detection result is that the IP address to be detected belongs to a normal IP address or unknown IP address, not display the prompt information.

6-10. (canceled)

11. An apparatus, comprising
one or more processor;
a memory;
one or more programs stored in the memory and configured to execute the following operation when executed by the one or more processors:
acquiring an internet protocol IP address corresponding to a Uniform Resource Locator URL accessed by a client, as an IP address to be detected;
performing malicious behavior detection for the IP address to be detected, to obtain a detection result.

12. A non-volatile computer storage medium in which one or more programs are stored, an apparatus being enabled to execute the following operations when said one or more programs are executed by the apparatus:
acquiring an internet protocol IP address corresponding to a Uniform Resource Locator URL accessed by a client, as an IP address to be detected;
performing malicious behavior detection for the IP address to be detected, to obtain a detection result.

13. The apparatus according to claim 11, wherein the performing malicious behavior detection for the IP address to be detected, to obtain a detection result comprises:
querying an IP address credit repository according to the IP address to be detected, to obtain a credit score of the IP address to be detected;
according to the credit score of the IP address to be detected, obtaining a detection result of the malicious behavior detection for the IP address to be detected.

14. The apparatus according to claim 13, wherein the operation further comprises:
collecting a malicious IP address;
obtaining the credit score of the malicious IP address according to at least one of a collection source of the malicious IP address and a data update frequency of the collection source;
correspondingly storing a normal IP address and a credit score of the normal IP address, the malicious IP address and a credit score of the malicious IP address, to generate the IP address credit repository.

15. The apparatus according to claim 14, wherein the operation further comprises:
according to a term of validity of the credit score, reducing the credit score of the malicious IP address after the term of validity, if the credit score of the malicious IP address in the IP address credit repository does not change within the term of validity.

16. The apparatus according to claim 11, wherein the operation further comprises:
if the detection result is that the IP address to be detected belongs to a malicious IP address, displaying a prompt information which is used to instruct the user to perform a corresponding operation; or,
if the detection result is that the IP address to be detected belongs to a normal IP address or unknown IP address, not display the prompt information.

17. The non-volatile computer storage medium according to claim 12, wherein the performing malicious behavior detection for the IP address to be detected, to obtain a detection result comprises:
querying an IP address credit repository according to the IP address to be detected, to obtain a credit score of the IP address to be detected;
according to the credit score of the IP address to be detected, obtaining a detection result of the malicious behavior detection for the IP address to be detected.

18. The non-volatile computer storage medium according to claim 17, wherein the operation further comprises:
collecting a malicious IP address;
obtaining the credit score of the malicious IP address according to at least one of a collection source of the malicious IP address and a data update frequency of the collection source;
correspondingly storing a normal IP address and a credit score of the normal IP address, the malicious IP address and a credit score of the malicious IP address, to generate the IP address credit repository.

19. The non-volatile computer storage medium according to claim 18, wherein the operation further comprises:
according to a term of validity of the credit score, reducing the credit score of the malicious IP address after the term of validity, if the credit score of the malicious IP address in the IP address credit repository does not change within the term of validity.

20. The non-volatile computer storage medium according to claim 12, wherein the operation further comprises:
if the detection result is that the IP address to be detected belongs to a malicious IP address, displaying a prompt information which is used to instruct the user to perform a corresponding operation; or,
if the detection result is that the IP address to be detected belongs to a normal IP address or unknown IP address, not display the prompt information.
